(19) United States
(12) Patent Application Publication
(10) Pub. No.: US 2024/0004947 A1
(43) Pub. Date: Jan. 4, 2024

(54) Systems and Methods of Determining Web Resource Relevance

(71) Applicant: Citrix Systems, Inc., Ft. Lauderdale, FL (US)

(72) Inventors: XIHUAN YANG, Nanjing (CN); MIN LI, Nanjing (CN); FEI SU, Nanjing (CN)

(73) Assignee: Citrix Systems, Inc., Ft. Lauderdale, FL (US)

(21) Appl. No.: 17/815,023

(22) Filed: Jul. 26, 2022

Related U.S. Application Data
(63) Continuation of application No. PCT/CN2022/102909, filed on Jun. 30, 2022.

(51) Int. Cl. G06F 16/957; G06F 16/9538

(52) U.S. Cl. CPC G06F 16/957; G06F 16/9538

(57) ABSTRACT

A computer system is provided. The computer system includes a memory; a user interface; and a processor coupled with the memory and the user interface. The processor is configured to detect, within a response addressed to a browser, one or more identifiers of one or more web resources; determine relevance information associated with the one or more web resources; embed the relevance information into the response to generate an augmented response; and communicate the augmented response to the browser.

### RELATED APPLICATION

This application claims priority under 35 U.S.C. § 120 as a continuation of PCT Application No. PCT/CN2022/102909, titled “Systems and Methods of Determining Web Resource Relevance” and filed Jun. 30, 2022, which is hereby incorporated herein by reference in its entirety.

### BACKGROUND

Some organizations maintain standard operating procedures, marketing materials, technical documentation, and other persistent knowledge within documents that are accessible via internet technologies (e.g., as web pages communicated to browsers by web servers). In these organizations, employees can both contribute to and draw from the organizational knowledge base. For example, if an employee needs information regarding a particular organizational practice, the employee can perform one or more keyword searches of the organizational knowledge base and browse to various web pages returned in the search results. These web pages may provide the employee with access to the needed information.

### SUMMARY

In at least one example, a method of augmenting web pages with relevance information is provided. The method includes detecting, within a response addressed to a browser, one or more identifiers of one or more web resources; determining relevance information associated with the one or more web resources; embedding the relevance information into the response to generate an augmented response; and communicating the augmented response to the browser.

At least some examples of the method incorporate one or more of the following features. In the method, determining the relevance information can include monitoring interactions between one or more users and the one or more web resources; generating interaction data specifying one or more features of the interactions; determining one or more scores for the one or more web resources based on the one or more features; and generating the relevance information based on the one or more scores. Generating the interaction data can include calculating at least one feature of the one or more features that is indicative of comprehensibility of at least one web resource of the one or more web resources. Calculating the at least one feature can include tracking time spent by users interacting with the at least one web resource. Tracking the time spent by users can include tracking time spent by users positioned within an identified role in an organization.

In the method, determining the relevance information can include determining relevance information specific to an organizational role of a user of the browser. Determining the relevance information can include determining one or more of a target role of at least one web resource of the one or more web resources, a resource quality of at least one web resource of the one or more web resources, or an indication of a most recent browser access of at least one web resource of the one or more web resources. The one or more web resources can include a plurality of web resources. Determining the resource quality can include identifying a plurality of clusters within the plurality of web resources.

In another example, a computer system is provided. The computer system includes at least one memory; and at least one processor coupled with the at least one memory. The at least one processor is configured to detect, within a response addressed to a browser, one or more identifiers of one or more web resources; determine relevance information associated with the one or more web resources; embed the relevance information into the response to generate an augmented response; and communicate the augmented response to the browser.

Examples of the computer system can incorporate one of more of the following features. In the computer system, to determine the relevance information can include to: monitor interactions between one or more users and the one or more web resources; generate interaction data specifying one or more features of the interactions; determine one or more scores for the one or more web resources based on the one or more features; and generate the relevance information based on the one or more scores. To generate the interaction data can include to calculate at least one feature of the one or more features that is indicative of comprehensibility of at least one web resource of the one or more web resources. To calculate the at least one feature can include to track time spent by users interacting with the at least one web resource. To track the time spent by users can include to track time spent by users positioned within an identified role in an organization.

In the computer system, to determine the relevance information can include to determine relevance information specific to an organizational role of a user of the browser. To determine the relevance information can include to determine one or more of a target role of at least one web resource of the one or more web resources, a resource quality of at least one web resource of the one or more web resources, or an indication of a most recent browser access of at least one web resource of the one or more web resources. The one or more web resources can include a plurality of web resources. To determine the resource quality can include to identify a plurality of clusters within the plurality of web resources.

In another example, one or more non-transitory computer readable media are provided. The media store processor executable instructions to determine relevance of web resources. The instructions include instructions to: detect, within a response addressed to a browser, one or more identifiers of one or more web resources; determine relevance information associated with the one or more web resources; embed the relevance information into the response to generate an augmented response; and communicate the augmented response to the browser.

Examples of the media can include one or more of the following features. The instructions to determine the relevance information can include instructions to: monitor interactions between one or more users and the one or more web resources; generate interaction data specifying one or more features of the interactions; determine one or more scores for the one or more web resources based on the one or more features; and generate the relevance information based on the one or more scores. The instructions to generate the interaction data can include instructions to calculate time spent by users interacting with at least one web resource of the one or more web resources. The instructions to determine the relevance information can include instructions to determine relevance information specific to an organizational role of a user of the browser.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, identical or nearly identical components that are illustrated in various figures are represented by like numerals. For purposes of clarity, not every component may be labeled in every figure.

FIG. 1 is a block diagram of a system of processes and data structures configured to determine relevance of web resources in accordance with an example of the present disclosure.

FIG. 2A is a flow diagram of a web resource clustering process in accordance with an example of the present disclosure.

FIG. 2B is a flow diagram of a web page augmentation process in accordance with an example of the present disclosure.

FIG. 3A is a flow diagram of a web resource interaction tracking process in accordance with an example of the present disclosure.

FIG. 3B is a block diagram of a dictionary of user interactions with web resources processable in accordance with an example of the present disclosure.

FIG. 4 is a flow diagram of a content scoring process in accordance with an example of the present disclosure.

FIG. 5A is a sequence diagram illustrating a process of clustering web resources by role in accordance with an example of the present disclosure.

FIG. 5B is a sequence diagram illustrating a process of augmenting a web page with relevance information in accordance with an example of the present disclosure.

FIG. 6 is a front view of a web page augmented with relevance information in accordance with an example of the present disclosure.

FIG. 7 is a block diagram of a network environment of computing devices in which various aspects of the present disclosure can be implemented.

FIG. 8 is a block diagram of the relevance determination system of FIG. 1 as implemented by a first configuration of computing devices in accordance with an example of the present disclosure.

FIG. 9 is a block diagram of the relevance determination system of FIG. 1 as implemented by a second configuration of computing devices in accordance with another example of the present disclosure.

FIG. 10 is a block diagram of the relevance determination system of FIG. 1 as implemented by a third configuration of computing devices in accordance with another example of the present disclosure.

FIG. 11 is a block diagram of the relevance determination system of FIG. 1 as implemented by a fourth configuration of computing devices in accordance with another example of the present disclosure.

FIG. 12 is a block diagram of the relevance determination system of FIG. 1 as implemented in a Software as a Service (SaaS) system in accordance with another example of the present disclosure.

### DETAILED DESCRIPTION

As summarized above, at least some examples described herein are directed to systems and methods that determine and communicate relevance of web resources to users. These web resources can specify a wide variety of content that is addressable via, for example, uniform resource locators (URLs) and accessible via various protocols. Examples of the web resources and protocols that the systems and methods disclosed herein can process include hypertext markup language (HTML) documents accessible via hypertext transport protocol (HTTP), secure HTML documents accessible via HTTP secure (HTTPS), image/video files accessible via file transport protocol (FTP), and other digital content. By monitoring user interaction with these web resources, the systems and methods described herein can communicate information to users that indicates the relevance of content included within the web resources. This relevance information can specify how frequently a given web resource is accessed by a user within a particular organizational role, a quality level (e.g., comprehensibility) of the content accessible within the web resource, and a recency of access of the web resource, among other information. By determining and providing relevance information to users, the systems and methods described herein address a number of issues and provide various benefits, including filling an informational void recognized as missing within other knowledge bases.

More specifically, in some examples, the systems and processes disclosed herein monitor interactions between users and web resources to determine a quality level of the web resources. For instance, in some examples, the systems and processes count the number of times each web resource is accessed, how recently each web resource is accessed, and whether user review of the content provided by the web resource indicates a user's effective engagement with the content. Further the systems and processes described herein analyze this interaction data to produce relevance information that includes scores indicative of web resource quality. For example, the scores can gauge frequency of access and web resource comprehensibility. In some examples, these scores can be generalized to all users or specific to particular organizational roles (e.g., a first score for salespeople and a second score for engineers). Additionally, in some examples, the systems and processes described herein monitor network traffic for identifiers of web resources and augment messages including identifiers of web resources with relevance information associated with the web resources and, in some examples, the organizational roles of the users who are to review the content encoded in the web resources.

The web resource relevance determination systems and processes described herein can be implemented within a variety of computing resources. For instance, in some examples, the systems and processes are implemented within a browser and/or a browser extension. Moreover, in some examples, the systems and processes are implemented within a virtualization infrastructure, such as the HDX virtualization infrastructure commercially available from Citrix Systems of Fort Lauderdale, Florida, in the United States. In these examples, the web resource recognition systems and processes can be implemented within a digital workspace application, such as the CITRIX WORKSPACE application; a browser embedded within the digital workspace application; a secure browser service, such as the CITRIX SECURE BROWSER service; a gateway appliance, such as the CITRIX APPLICATION DELIVERY CONTROLLER (ADC); a virtualization agent; and/or other computing resources.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Relevance Determination System

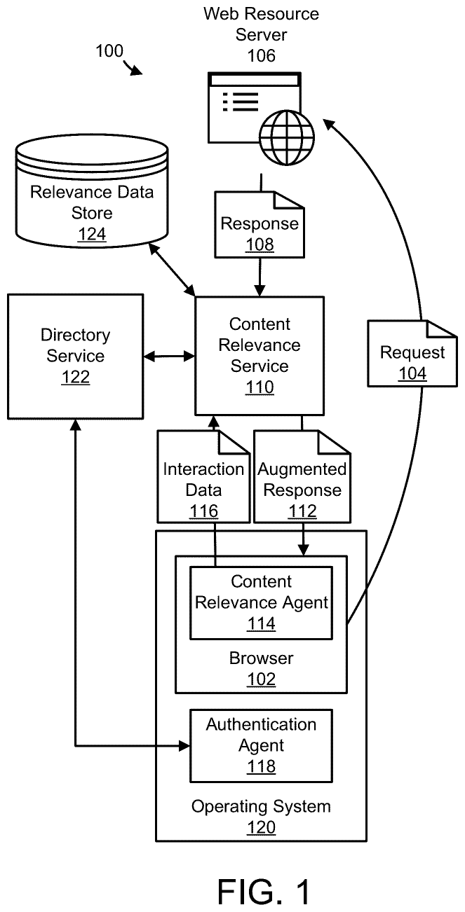

In some examples, a system is configured to determine and communicate relevance of web resources to users. FIG. 1 illustrates a logical architecture of a relevance determination system 100 in accordance with these examples.

As shown in FIG. 1, the system 100 includes a relevance data store 124 and several computer-implemented processes: a browser 102, a web resource server 106, a content relevance service 110, a content relevance agent 114, an authentication agent 118, an operating system 120, and a directory service 122 (which may implement an identity provider, in some examples). Each of the computer-implemented processes illustrated in FIG. 1 is executable via circuitry included in a host device. As such, references herein to actions of a computer-implemented process, or actions that a computer-implemented process is configured to execute, should be understood as being effectuated, or as being configured to be effectuated, via the circuitry of the device hosting the computer-implemented process.

FIG. 1 also illustrates lines of communication between computer-implemented processes. For instance, in some examples, the browser 102 is configured to transmit a request 104 and receive an augmented response 112. In some examples, the server 106 is configured to receive the request 104 and to transmit a response 108. In some examples, the service 110 is configured to receive interaction data 116, transmit the augmented response 112, and receive or intercept the response 108 (depending on the particular configuration of the system 100, as discussed below). In some examples, the service 110 is also configured to interoperate with the data store 124 and the service 122. In some examples, the agent 114 is configured to transmit the interaction data 116 to the service 110. In some examples, the authentication agent 118 is configured to interoperate with the service 122. Additional details regarding these and other communications are provided below, but it should be noted that the depicted lines of communication can include inter-process communication (e.g., where two or more of the computer-implemented processes illustrated in FIG. 1 reside within the same execution environment) and network-based communication (e.g., where two or more of the processes reside in different execution environments coupled to one another by a computer network).

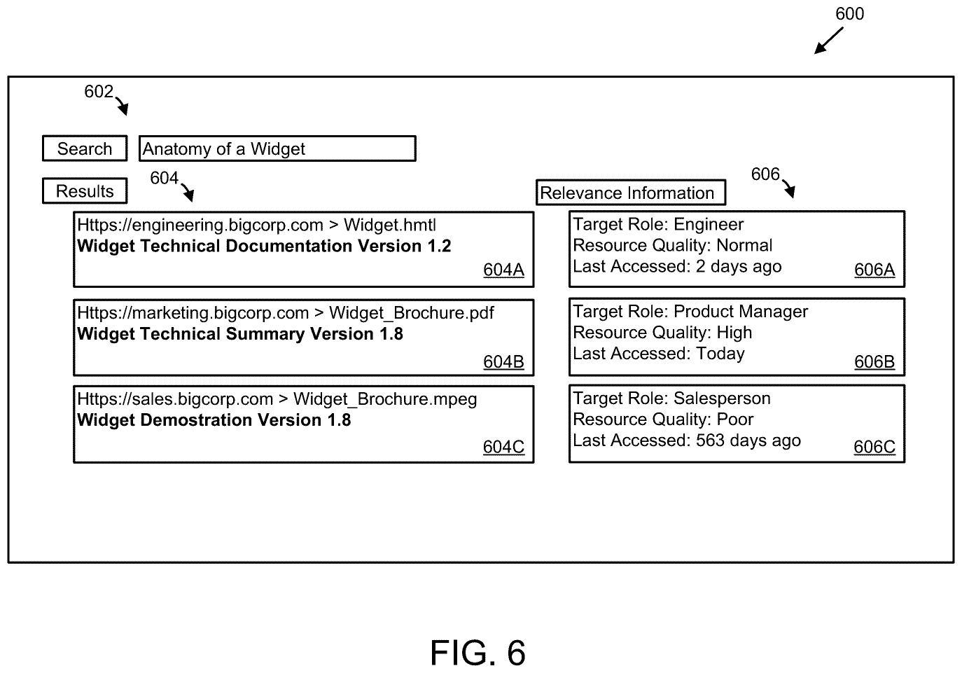

Turning now to the computer-implemented processes illustrated in FIG. 1, the browser 102 is configured to receive user input specifying identifiers (e.g., URLs) of web resources and to interoperate with a server (e.g., the server 106) to load and process responses encoding the web resources. The type of processing executed by the browser 102 depends on the type of web resource. For instance, when the web resource is a web page, the browser 102 renders HTML content included within the web page via a user interface of a host device and/or executes instructions (e.g., JavaScript) included within the web page. When the web resource is an image file stored on an FTP server, the browser 102 interoperates with the FTP server to receive the image file and render the image file via the user interface. Other modes of operation for the browser 102 will be apparent, however, as illustrated in FIG. 1, the browser 102 is configured to communicate with the server 106 and, in particular, to transmit a request 104 (e.g., an HTTP request) to the server 106. The request 104 can identify a web resource (e.g., via a URL) requested by the browser 102. The browser 102 is also configured to load and process a response from the server 106 (e.g., the augmented response 112) and to render web content specified in the response via a user interface. As described further below, the augmented response 112 can specify web resource content and embedded relevance information, such as the relevance information depicted in FIG. 6 below. In some examples, the relevance information is specific to the role of a user of the browser 102. The browser 102 can include an independent, commercially available browser (e.g., the CHROME browser available from Google LLC of Mountain View, California in the United States) or an embedded browser (e.g., a browser based on the CHROMIUM open source project supported by Google LLC).

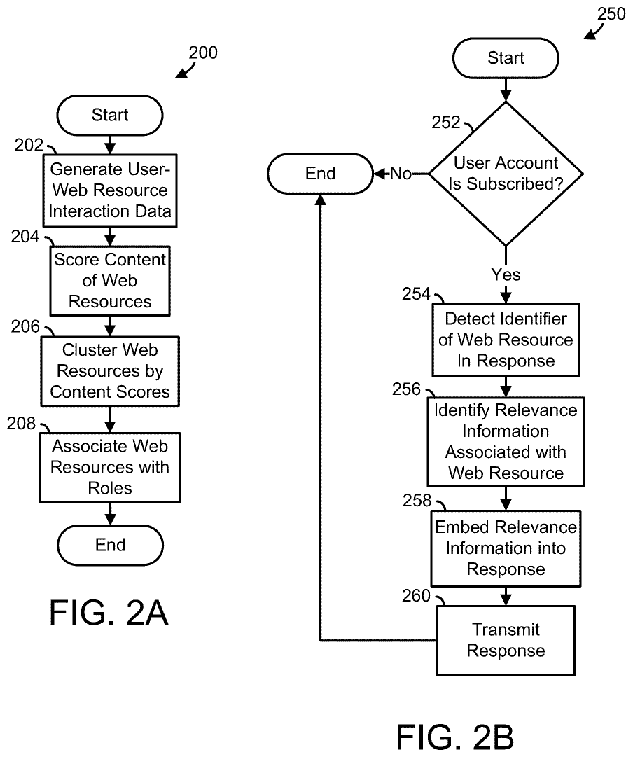

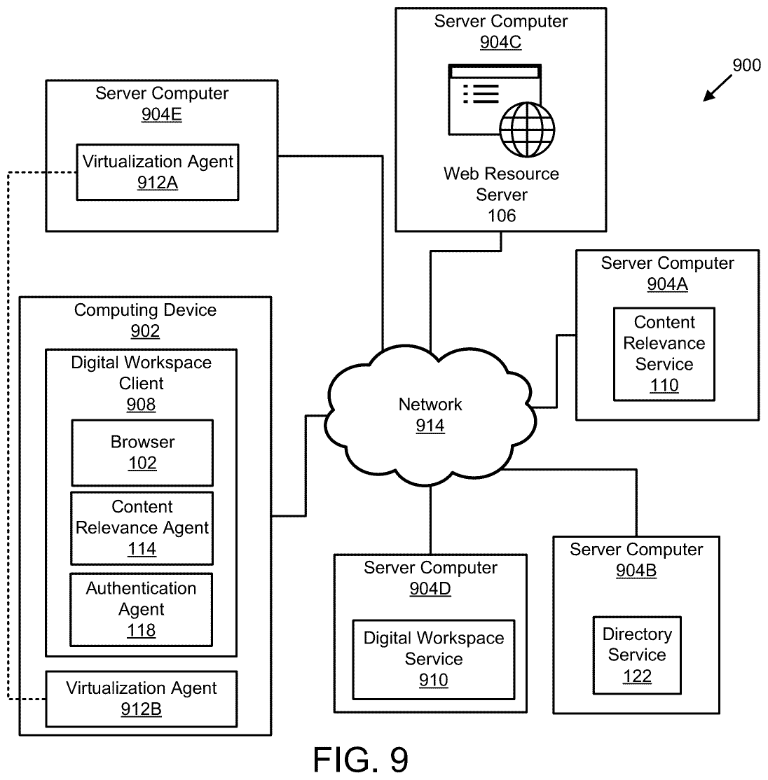

In some examples, the browser 102 is configured to interact with a user via a user interface of a device hosting the browser 102. These interactions can include, for example, opening web resources, navigating to and rendering specific portions of content specified within the web resources, and closing web resources, all in response to user input requesting the same. In some examples, the agent 114 is configured to monitor interactions between the user and the browser 102 and to generate the interaction data 116 based on the interactions between the user and the browser 102. The interaction data 116 can specify, for example, the time spent by the user reviewing and interacting with the content. In certain examples, the agent 114 is also configured to communicate (e.g., transmit) the generated interaction data 116 to the service 110 for subsequent analysis. Examples of processes that the agent 114 is configured to execute according to these configurations are described further below with reference to FIGS. 2A, 3A, 3B, and 5A. In some examples, the agent 114 is implemented as an extension to the browser 102, although this architecture is not a requirement. In other examples, the agent 114 executes independently of the browser 102 and subscribes to user interface events published by the browser 102 and/or the operating system 120 of the host device. Further, in some examples, the browser 102 is embedded within a digital workspace client and the agent 114 is also a process hosted by the digital workspace client. In these examples, the digital workspace client is configured to monitor operation of the embedded browser 102 for user interface events and to communicate the same to the agent 114. Digital workspaces are described further below with reference to FIG. 9. Other methods by which the agent 114 can acquire information regarding interactions between the browser 102 and users will be apparent.

Continuing with examples illustrated by FIG. 1, the service 110 is configured to receive and process the interaction data 116. This processing can include scoring content encoded within web resources based on the interaction data 116 to indicate the content's overall quality and comprehensibility. Additionally, in some examples, the service 110 is configured to interoperate with the data store 124 to identify clusters of web resources having similar quality and to associate the clusters with one or more user roles within an organization. In these examples, the service 110 is configured to update relevance information stored in the data store 124 with reference to the identified clusters and the role-specific quality thereof. This relevance information can include one or more roles most likely to be interested in content within a role-specific cluster, the comprehensibility of the content, and the date the content was last accessed. Examples of processes that the service 110 is configured to execute according to these configurations are described further below with reference to FIGS. 2A, 4, and 5A.

In certain implementations, the user roles referenced by the service 110 can be defined, for example, within a data structure that associates user identifiers with organizational roles. This data structure can be maintained, for example, by the service 110 within the data store 124 and/or within a data store maintained by the service 122, a human resources system, or some other system. Further, in some examples, the service 110 is configured to maintain a data structure in the data store 124 that associates user accounts and subscriptions to the relevance service and a data structure that stores relevance information by web resource identifier and, in some examples, by user and/or user role.

Continuing with examples illustrated by FIG. 1, the server 106 is configured to receive, process, and respond to requests (e.g., HTTP messages) for access to web resources hosted by the server 106. In examples directed to organizational intranets, these web resources can include various documents, images, and/or videos prepared by and for users, such as employees, who are affiliated with an organization. As illustrated in FIG. 1, the server 106 is configured to receive and process the request 104 from the browser 102. As a part of such processing, the server 106 can generate the response 108 based on data specified in the request 104, for example by initiating and/or interoperating with other processes, such as a search engine, and can transmit the response 108. The response 108 can specify, for example, web resource content such as search results, a web page, an mpeg file, or the like. The server 106 can include any commercially available or independently developed web server such as the NGINX web server commercially available from NGINX, Inc. of San Francisco, California in the United States or the APACHE HTTP SERVER web server commercially available from the Apache Software Foundation of Wilmington, Delaware in the United States, among others.

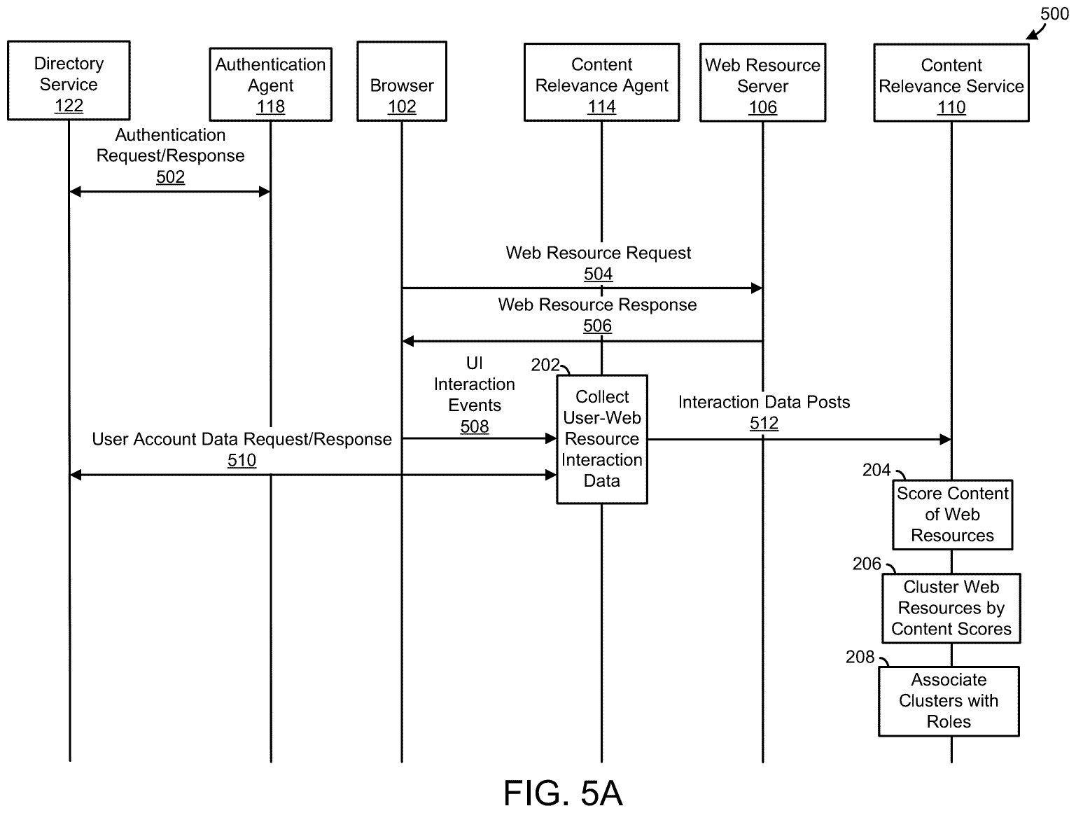

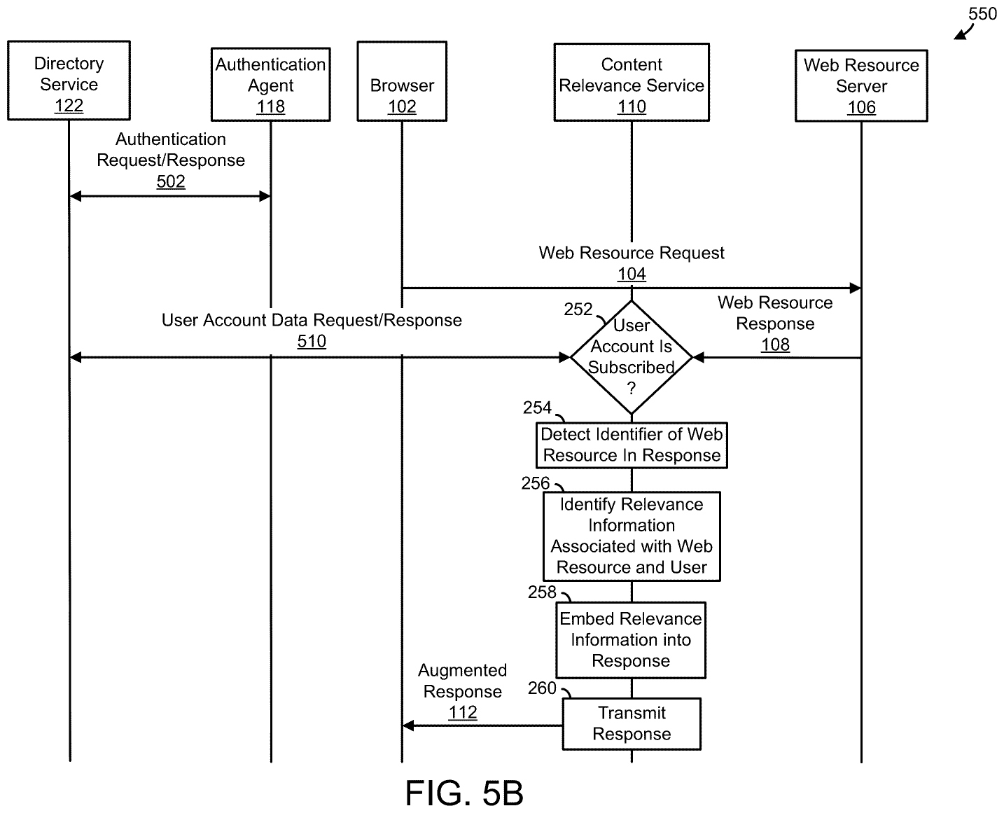

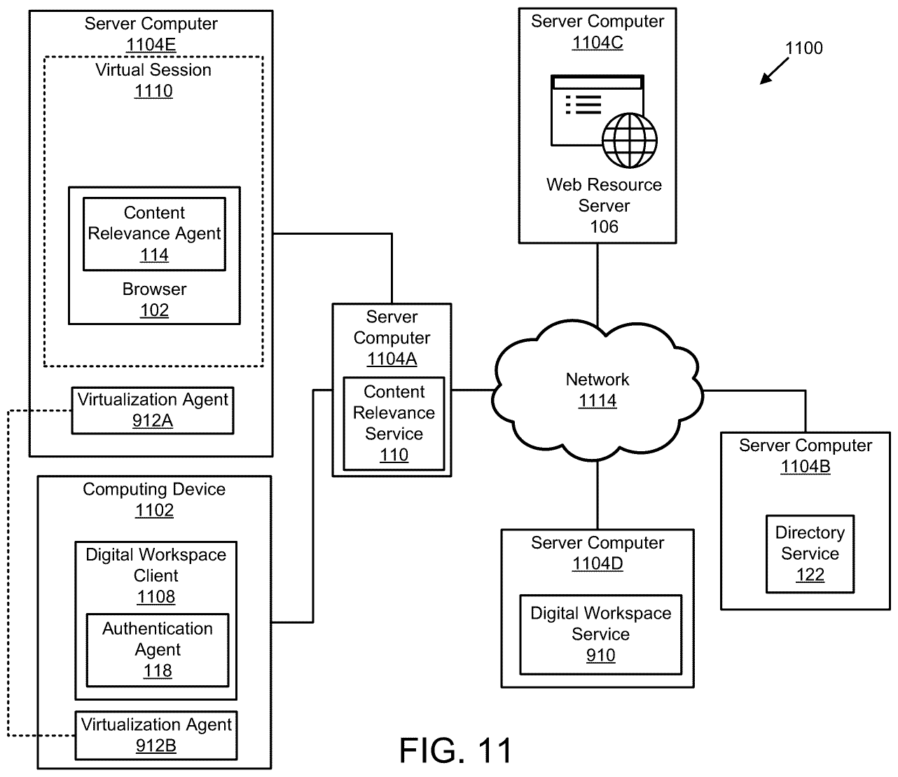

Continuing with examples illustrated by FIG. 1, the service 110 is configured to intercept and process the response 108. For instance, in some examples, the service 110 is hosted by a computing device (e.g., a server computer 1104A of FIG. 11) that is positioned between the server 106 and the browser 102 along a network route connecting the server 106 and the browser 102. In these examples, the service 110 is configured to interoperate with the service 122 and the data store 124 to determine whether a user account authenticated via, and associated with, the browser 102 and/or the agent 118 is subscribed to receive responses augmented with relevance information. Further, in these examples, the service 110 includes a proxy server that is configured to monitor network traffic for messages addressed to browsers associated with subscribed users (e.g., the browser 102) and to intercept responses (e.g., the response 108) addressed to the browsers. Further, in these examples, the service 110 is configured to augment the responses by embedding relevance information therein. In some examples, the relevance information is tailored to the role of the authenticated user account. As such, in some implementations, the service 110 is configured to interoperate with the data store 124 and the directory service 122 to generate and transmit an augmented response 112 to the browser 102. The augmented response 112 can specify, for example, the content from the response 108 and embedded relevance information applicable to the content and a user authenticated with the operating system 120 via the agent 118 and the service 122. Examples of processes that the service 110 is configured to execute according to these configurations are described further below with reference to FIGS. 2B and 5B.

It should be noted that the service 110 can be configured to receive, rather than intercept, the response 108. For instance, in some implementations, the agent 114 is configured to monitor for responses received by the browser 102 and then relay the responses to the service 110. Such an implementation can be particularly helpful where no intermediate device exists between the server 106 and the browser 102. Further, in these examples, the service 110 can be hosted by the same device as the agent 114 and the browser 102.

FIG. 2A is a flow diagram illustrating a web resource clustering process 200 useful to organize web resource content in some implementations. The process 200 can be executed, for example, by a relevance agent (e.g., the agent 114 of FIG. 1) and a relevance service (e.g., the service 110 of FIG. 1).

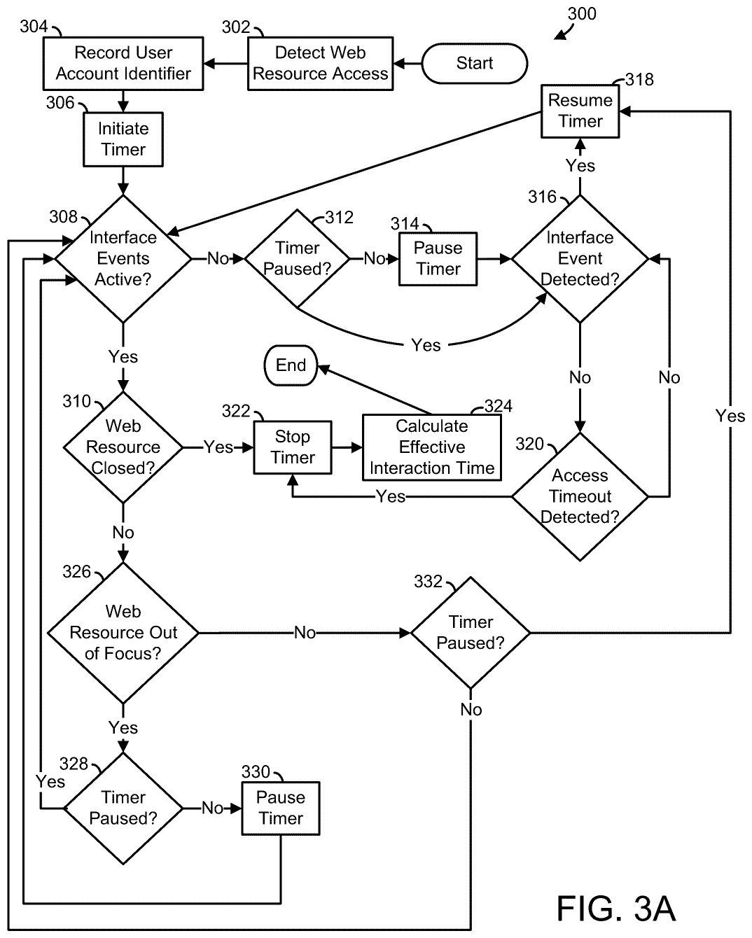

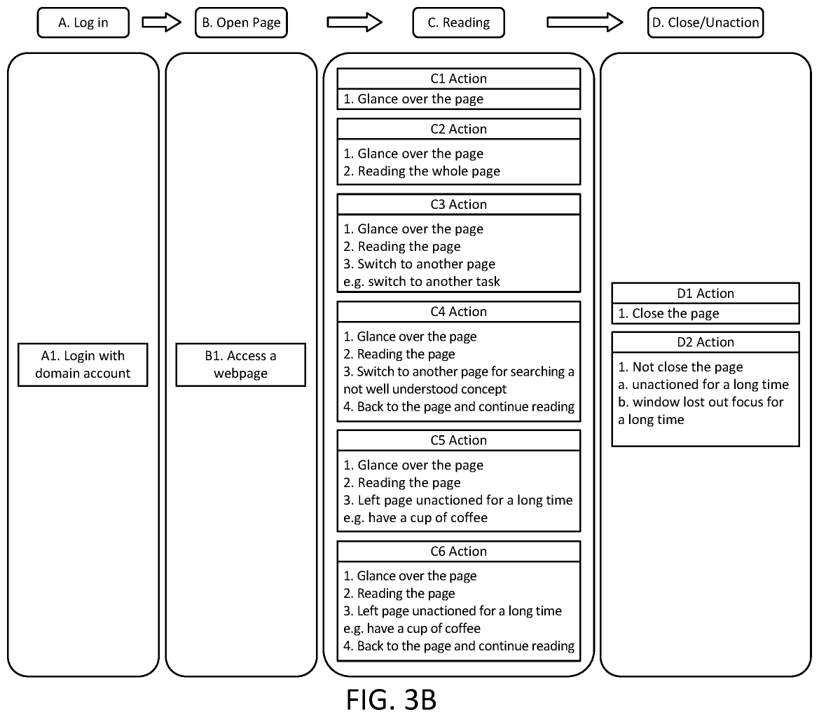

As shown in FIG. 2A, the process 200 starts with the relevance agent generating 202 interaction data (e.g., the interaction data 116 of FIG. 1) that specifies features of interactions between a user and a web resource. For instance, in some examples, the relevance agent executes a tracking process within the operation 202, such as the tracking process 300 illustrated with reference to FIG. 3A. The tracking process 300 is useful to identify meaningful interaction between a user and web resource content.

As shown in FIG. 3A, the process 300 starts with the relevance agent detecting 302 browser access to a web resource. For instance, in some examples, the relevance agent receives a message from another process (e.g., the browser 102 of FIG. 1, the operating system 120 of FIG. 1, or other process) that indicates a browser (e.g., the browser 102) being monitored by the relevance agent is about to load and process web resource content encoded in a response (e.g., the augmented response 112 or a response without embedded relevance information).

Continuing with the process 300, the relevance agent records 304 an identifier of a user authenticated through either the browser or another authentication agent (e.g., the authentication agent 114 of FIG. 1). For instance, in some examples, the relevance agent stores a user account identifier of the authenticated user in a data structure allocated in memory local to the device hosting the relevance agent. This data structure may be configured to house other fields of the interaction data.

Continuing with the process 300, the relevance agent initiates 306 a timer. For instance, in some examples, the relevance agent initiates a computer-implemented process on the host device that is configured to accumulate time elapsed while the control is active (e.g., not paused).

Continuing with the process 300, the relevance agent determines 308 whether the user interface is interacting with the user with a frequency sufficient to indicate that the user is actively engaging with the web resource content. For instance, in some implementations, the relevance agent determines whether the browser has received one or more user interface events generated from user input within a configurable timeout period (e.g., 5 events per minute, 10 events per minute, 20 events per minute, etc.). In some examples the timeout period is specific to the type of content being accessed and/or the amount of content presentable by the user interface without user input beyond that required for initial or progressive access. For instance, if the type of content is text, the timeout period may be shorter as the user may need to scroll through the content while reading it. As another example, if the type of content is a video or audio, the timeout period may be longer as the user can continue to meaningfully review the content without providing additional input via the user interface. If the relevance agent determines that the user interface is inactive, the relevance agent proceeds to operation 312.

Continuing with the process 300, the relevance agent determines 312 whether the timer is paused. If the relevance agent determines that the timer is paused, the relevance agent proceeds to operation 316. If the relevance agent determines that the timer is not paused, the relevance agent proceeds to operation 314.

Continuing with the process 300, the relevance agent pauses 314 the timer. Next, the relevance agent determines 316 whether a user interface event has been detected since the last time such a determination was made (e.g., in either the operation 308 or the operation 316). If the relevance agent determines that a user interface event has been detected, the relevance agent proceeds to operation 318. If the relevance agent determines that a user interface event has not been detected, the relevance agent proceeds to operation 320.

Continuing with the process 300, the relevance agent resumes (e.g., reactivates) 318 the timer and returns to the operation 308.

Continuing with the process 300, the relevance agent determines 320 whether a configurable timeout period has transpired since the most recent user interface event was detected. Transpiration of this timeout period indicates that the user is no longer meaningfully interacting with the content. If the relevance agent determines that the timeout period has transpired, the relevance agent proceeds to operation 322. If the relevance agent determines that the timeout period has not transpired, the relevance agent returns to the operation 316.

Continuing with the process 300, the relevance agent stops 322 the timer. Next, the relevance agent calculates 324 an effective interaction time between the user and the web resource based on the elapsed time accumulated by the timer. For instance, in some examples, the relevance agent calculates the effective interaction time to be the time accumulated by the timer, if the accumulated time exceeds a configurable threshold value (e.g., 30 seconds, 1 minute, 5 minutes, etc.). In some examples, the relevance agent autonomously sets this configurable threshold value to be a percentage (e.g., 25%, 50%, 75%, etc.) of a runtime of the content (for audio and/or video) and/or review time estimated for the content by another process, such as the READ-O-METER process available at https://niram.org/read/. Within the operation 324, the relevance agent communicates the interaction data 116 to the relevance service. This interaction data 116 specifies an identifier of the web resource, an identifier of the user, and the effective reading time. In some examples, the interaction data 116 can further include a log of messages (e.g., events and other messages) received and processed by the browser beginning with the browser's request for the web resource and ending with the browser terminating access to the web resource. This chronology can include a timestamped entry for each message. In some examples, the interaction data 116 can further include an indication as to the amount of content interacted with by the user (e.g., total word count for textual content, number of words rendered via the user interface for textual content, seconds of content rendered for audio and/or video content, etc.). Subsequent to the operation 324, the process 300 ends.

Returning to the operation 308, if the relevance agent determines that the user is actively interacting with the user interface, the relevance agent proceeds to operation 310.

Continuing with the process 300, the relevance agent determines 310 whether the browser has discontinued access to the content of the web resource. For instance, in some examples, the relevance agent detects execution of a close event by the browser. If the relevance agent determines that the browser has discontinued access to the web resource, the relevance agent proceeds to the operation 322. If the relevance agent determines that the browser has not discontinued access to the web resource, the relevance agent proceeds to operation 326.

Continuing with the process 300, the relevance agent determines 326 whether the browser window through which the web resource content is render is out of focus, and thus likely being ignored by the user. For instance, in some examples, the relevance agent receives a message from the browser indicating that the window has lost focus. If the relevance agent determines that the browser window is out of focus, the relevance agent proceeds to operation 328. If the relevance agent determines that the browser window is not out of focus, the relevance agent proceeds to operation 332.

Continuing with the process 300, the relevance agent determines 332 whether the timer is paused. If the relevance agent determines that the timer is paused, the relevance agent proceeds to the operation 318. If the relevance agent determines that the timer is not paused, the relevance agent returns to the operation 308.

Continuing with the process 300, the relevance agent determines 328 whether the timer is paused. If the relevance agent determines that the timer is paused, the relevance agent returns to the operation 308. If the relevance agent determines that the timer is not paused, the relevance agent proceeds to operation 330.

Continuing with the process 300, the relevance agent pauses 330 the timer and returns to the operation 308.

FIG. 3B is a block diagram illustrating possible values of vector elements that the process 300 can analyze to generate interaction data when a user is reading a web page. Table 1 lists vectors built from the vector elements of FIG. 3B and effective reading time rules implemented by the process 300.

TABLE 1

| Reading Behavior | Effective Reading Time Rules |
|---|---|
| A1-B1-C1-D1 | 1) A timer begins when a web page is loaded and keyboard or |
| A1-B1-C2-D1 | mouse events are detected on the web page. |
| A1-B1-C3-D1 | 2) The timer continues while scrolling, keyboard, or mouse events |
| A1-B1-C4-D1 | are detected on the web page at regular intervals. These actions |
| A1-B1-C5-D1 | indicate that user is still reading. |
| A1-B1-C6-D1 | 3) The timer is paused when a web page switch is detected. |
| A1-B1-C1-D2 | 4) The timer is paused when scrolling, keyboard, or mouse events |
| A1-B1-C2-D2 | are not detected for a regular interval. |
| A1-B1-C3-D2 | 5) The timer resumes when the web page is switched back and |
| A1-B1-C4-D2 | again in focus. |
| A1-B1-C5-D2 | 6) The timer resumes when scrolling, keyboard, or mouse events |
| A1-B1-C6-D2 | are detected again. |
| | 7) The timer is stopped when the page is closed. |
| | 8) The timer is stopped when the page session has expired. |
| | If the time accumulated by the timer is less than a configurable value, |
| | set the effective time to 0. |

For example, the first vector listed in Table 1 “A1-B1-C1-D1” represents the following user actions. The user authenticates to the domain (e.g., via the agent 118 and service 122 of FIG. 1). The user accesses a web page (e.g., via the browser). The user glances over the web page. The user closes the web page. Other example vectors of user behavior that the process 300 can analyze to generate interaction data will be apparent.

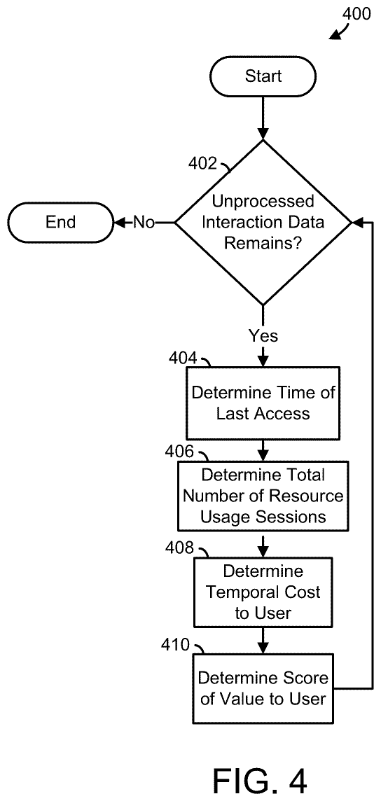

Returning to the process 200, the relevance service scores 204 content of web resources. For instance, in some examples, the relevance service executes a content scoring process within the operation 204, such as the scoring process 400 illustrated with reference to FIG. 4. The scoring process 400 is useful to determine the comprehensibility and overall quality of content encoded within web resources based on interactions between the content and users. In some examples, the relevance service executes the process 400 for each web resource with unprocessed interaction data stored in a relevance data store (e.g., the data store 124 of FIG. 1).

As shown in FIG. 4, the process 400 starts with the relevance service determining 402 whether unprocessed interaction data for a web resource remains in the relevance data store. For instance, in some examples, the relevance service transmits, to the relevance data store, a query for unprocessed interaction data and determines that unprocessed interaction data remains if the relevance data store returns data in response to the query. If the relevance service determines that unprocessed interaction data for a web resource remains, the relevance service identifies the web resource for further processing and proceeds to operation 404. If the relevance service determines that no unprocessed interaction data remains, the process 400 ends.

Continuing with the process 400, the relevance service determines 404 a date and time at which the web resource was last accessed by a browser. For instance, in some examples, the relevance service queries the relevance data store to retrieve a timestamp indicating the date and time of most recent access for the web resource and stores the timestamp in association with an identifier of the web resource in the relevance data store. It should be noted that, in some examples, the timestamp records generated and stored in the operation 404 can be grouped by and associated with an identifier (e.g., user account identifier) of an authenticated user of the browser at the time specified by the timestamp and/or can be grouped by and associated with an identifier of the user's role as retrieved from a directory service (e.g., the service 122 of FIG. 1) by the relevance service.

Continuing with the process 400, the relevance service determines 406 a total number of visits to the web resource that involved effective interaction with a user. For instance, in some examples, the relevance service queries the relevance data store to retrieve a total number of web resource interactions in which the effective interaction time is greater than 0 and stores the total number, Tₜ, in association with an identifier of the web resource in the relevance data store. It should be noted that, in some examples, the effective interaction records generated and stored in the operation 406 can be grouped by and associated with an identifier of an authenticated user of the browser during the interactions and/or with an identifier of the user's role as retrieved from the directory service by the relevance service.

Continuing with the process 400, the relevance service determines 408 an interaction cost for the web resource. For web resources that encode textual content, the interaction cost can be determined per word. For instance, in some examples, the relevance service queries the relevance data store to retrieve a total amount of interaction time, Tₛ, for the web resource and divides the total amount of interaction time by the total number of effective resource visits to determine an average resource interaction time, Tₐ. Next, within the operation 408, the relevance service calculates an interaction cost per word by dividing Tₐ by a count of words within the content C_{w}, and stores the interaction cost per word in association with an identifier of the web resource in the relevance data store.

In some examples, the calculations described above can be summarized by the following two equations.

$$\\ {T}_{w} = \frac{{T}_{a}}{{C}_{w}} and {T}_{a} = \frac{{T}_{s}}{{T}_{t}}$$

For web resources that encode audio and/or video content, the interaction cost can be determined per second of play back. For instance, in some examples, the relevance service queries the relevance data store to retrieve a total amount of interaction time, Tₛ, for the web resource and divides the total amount of interaction time by the total number of effective resource visits to determine an average resource interaction time, Tₐ. Next, within the operation 408, the relevance service calculates an interaction cost per second by dividing T a by a total number of play back seconds within the content Cₛ and stores the interaction cost per second in association with an identifier of the web resource in the relevance data store. It should be noted that, in some examples, the relevance service calculates the variables Cₛ, or C_{w} to be an average amount of content reviewed based on the total amount of content reviewed by users and the total number of effective visits, Tₜ. It should also be noted that, in some examples, the interaction cost records generated and stored in the operation 408 can be grouped by and associated with an identifier of an authenticated user of the browser during the interactions and/or with an identifier of the user's role as retrieved from the directory service by the relevance service.

Continuing with the process 400, the relevance service determines 410 one or more scores for the web resource. For instance, in some examples, the relevance service determines a set of scores based on features of interactions between users and the web resource, such as the features described above. In these examples, the relevance service obtains a feature score for each feature of the set of features by identifying the feature and the feature's value within a data structure that associates feature values with feature scores. In some examples, the features of a web resource used for scoring include the timestamp of the most recent access for the web resource, the total number of effective web resource visits, and the interaction cost of the web resource. Table 2 lists rules used by some implementations of the relevance service to assign scores to these features.

TABLE 2

| Feature | Scoring Rules |
|---|---|
| Timestamp of most | 5: Visited within past 0 to 7 days |
| recent access | 4: Visited within past 8 to 14 days |
| | 3: Visited within past 15 to 30 days |
| | 2: Visited within past 31to 60 days |
| | 1: Visited greater than 60 days ago |
| | 0: Visited greater than 180 days ago |
| Total number of | 5: Visited >10000 times |
| effective visits | 4: Visited 5000-9999 times |
| | 3: Visited 500-4999 times |
| | 2: Visited 100-499 times |
| | 1: Visited 5-99 times |
| | 0: Visited <5 times |
| Interaction cost | 0: <0.00200 (>500 words per minute) |
| (average reading rate) | 1: 0.00200-0.00221 (500-451 |
| | words per minute) |
| | 2: 0.00222-0.00249 (450-401 |
| | words per minute) |
| | 3: 0.00250-0.00285 (400-351 |
| | words per minute) |
| | 4: 0.00286-0.00332 (350-301 |
| | words per minute) |
| | 5: 0.00333-0.00500 (300-200 |
| | words per minute) |
| | 4: 0.00503-0.00588 (199-170 |
| | words per minute) |
| | 3: 0.00592-0.00714 (169-140 |
| | words per minute) |
| | 2: 0.00719-0.00909 (139-110 |
| | words per minute) |
| | 1: 0.00917-0.01250 (109-80 |
| | words per minute) |
| | 0: 0.01250 > (<80 words |
| | per minute) |

For example, when configured according to Table 2, the relevance service obtains a first feature score of 5 for a web resource if the web resource was last visited 3 days ago, a second feature score of 4 for the web resource if the web resource has been visited a total of 5789 times, and a third feature score of 3 if the web resource has an interaction cost of 0.00600. In some examples, within the operation 204, the relevance service calculates a total score for the web resource (in this example 12) and stores the total score in association with an identifier of the web resource in the relevance data store. In certain examples, within the operation 204, the relevance service normalizes the feature scores to range between 0 and 1 and stores a vector including the three feature scores in association with an identifier of the web resource within the relevance data store. It should be noted that the scoring rules for interaction cost listed in Table 2 assign higher scores for content that is read at a rate near the average for content articulated in the English. In this way, content with a low interaction cost that is skimmed or otherwise briefly reviewed (e.g., due to not being useful or of interest) and content with a high interaction cost that is reviewed slowly (e.g., due to being difficult to comprehend) is assigned a low score relative to content that is reviewed a normal pace. It should also be noted that the rules listed in Table 2 for scoring interaction cost are applicable to English language content. Content articulated in other languages may be scored using other rules. It should also be noted that, in some examples, the feature scores generated and stored in the operation 410 can be grouped by and associated with identifiers of users and/or user roles associated with underlying features and feature values. As such, in these examples, a web resource may have a first set of feature scores with reference to a first user role and may have a different, second set of feature scores with reference to a second user role.

Returning to the process 200, the relevance service clusters 206 web resources using the feature vectors constructed in the operation 204. For instance, in some examples, the relevance service executes a k-means process to cluster the web resources. While the number of clusters identified is configurable and varies between examples, in at least some examples, three clusters are identified: a first cluster for high quality web resources, a second cluster for normal quality web resources, and a third cluster for poor quality web resources. It should be noted that, in examples where feature scores are group by and associated with identifiers of users and/or user roles, the clusters identified by the k-means process can be specific to users and/or user roles. As such, a first web resource may belong to a high-quality cluster associated with a first user role (e.g., salesperson) and associated with a low-quality cluster for a second role (engineer). This reflects the fact that users trained for specific roles exhibit different behaviors for the same web resource.

Continuing with the process 200, the relevance service associates 208 web resources with user roles. For instance, in some examples, the relevance service interoperates with the relevance data store to determine a number of effective interactions between each user role and each web resource and stores each determined number in association with its corresponding web resource in the relevance data store. Further, in these examples, the relevance service interoperates with the relevance data store to identify a target user role as having the highest number of effective interactions and/or best interaction cost with the web resource and stores the identified user role in association with the web resource in the relevance data store. Subsequent to execution of the operation 208, the process 200 ends.

FIG. 2B is a flow diagram of a web page augmentation process 250 in accordance with an example of the present disclosure. The augmentation process 250 is useful to embed relevance information in responses to enhance the information provided to users. In some examples, the relevance service executes the process 250 for each response it receives or intercepts.

As shown in FIG. 2, the process 250 starts with the relevance service determining 252 whether a user account associated with the browser (e.g., the browser 102 of FIG. 1) to which a response (e.g., the response 108 of FIG. 1) is addressed is a subscribed to receive relevance information. For instance, in some examples, the relevance service identifies an internet protocol (IP) address from a transmission control protocol (TCP) connection (involving the browser) to which the response is addressed and interoperates with the directory service to identify a user account associated with the IP address. Next, in these examples, the relevance service interoperates with the relevance data store to determine (e.g., with reference to a data structure that stores identifiers of subscribed user accounts) whether the identified user account is subscribed to receive relevance information. If the relevance service determines that the user account is subscribed to receive relevance information, the relevance service proceeds to operation 254. If the relevance service determines that the user account is not subscribed to receive relevance information, the process 250 ends.

Continuing with the process 250, the relevance service detects 254 one or more identifiers of one or more web resources in the response. For instance, in some examples, the relevance service scans HTML specified by the response for one or more URLs. These URLs may include the URL specified in a request (e.g., the request 104 of FIG. 1) corresponding to the response and/or URLs specified in the body of the response.

Continuing with the process 250, the relevance service identifies 256 relevance information associated with the one or more web resources. For instance, in some examples, the relevance service interoperates with the relevance data store to retrieve relevance information associated with the one or more identifiers detected in the operation 254.

Continuing with the process 250, the relevance service embeds 258 the retrieved relevance information within the response to generate an augmented response (e.g., the augmented response 112). For instance, in some examples, the relevance service restructures the response to visually communicate an association between the relevance information and information regarding the one or more web resources associated with the relevance information. The format of the augmented response can vary between examples, but FIG. 6 illustrates an augmented response according to some examples in which the relevance service utilizes proximity to visually communicate associations between relevance information and web resources.

FIG. 6 is a front view of a response augmented with relevance information when rendered as a user interface screen 600 by a browser. As shown in FIG. 6, the screen 600 includes a search control 602, search results controls 604 (individually controls 604A, 604B, and 604C), and relevance information controls 606 (individually controls 606A, 606B, and 606C). The search results controls 604A, 604B, and 604C display information regarding three distinct web resources. The relevance information controls 606A, 606B, and 606C display three distinct sets of relevance information that correspond to the web resources of controls 604A, 604B, and 604C. It should be noted that, in some examples, the relevance service can identify the target roles specified in the controls 606 by interoperating with the relevance service to identify a user role associated with the highest total score for each web resource. For example, given the following combinations of user role and score for the web resource identified in control 604A: [Engineer, 10]; [Product Manager, 8]; [Salesperson, 5], the relevance service determines that the target role for the web resource is Engineer. Similarly, values for the Resource Quality and Last Accessed fields of relevance information controls 606 can be based on user role, in some examples.

Returning to the process 250, the relevance service transmits 260 the augmented response to the browser. For instance, in some examples, the relevance service transmits the augmented response to the browser via an HTTP response to the request originally transmitted by the browser on the TCP connection referenced above. Subsequent to the operation 260, the process 250 ends.

FIG. 5A is a sequence diagram illustrating a process 500 of gathering interaction data and clustering web resources by role in accordance with an example of the present disclosure. As shown in FIG. 5A, the process 500 includes selected interoperations between processes depicted in FIG. 1.

The process 500 starts with the agent 118 interoperating with the service 122 to authenticate a user. The interoperations between the agent 118 and the service 122 can include authentication request and response messages 502. The agent 118 can be hosted by and establish user authentication with various execution environments in accordance with the examples described herein. These execution environments can include an operating system (e.g., the operating system 120 of FIG. 1) of a host device, a browser (e.g., the browser 102 of FIG. 1), and/or a digital workspace (e.g., as illustrated in FIGS. 9-11).

Continuing with the process 500, the browser 102 communicates a web resource request message (e.g., an HTTP request) 504 to the server 106. The server 106 processes the request 504 to generate and transmit a web resource response message (e.g., an HTTP response) 506 to the browser 102.

Continuing with the process 500, the agent 114 executes the operation 202 described above with reference to FIG. 2A to collect and post interaction data 512 to the service 110. In so doing, the agent 114 processes user interface interaction events 508 generated by a user interface of a host device from interactions between the authenticated user and the browser 102. The operation 202 uses these events 508 to generate interaction data (e.g., the interaction data 116 of FIG. 1). Also, within the operation 202, the agent 114 interoperates with the service 122 via user account data request and response messages 510 to retrieve a user identifier (e.g., a user account identifier) to include in the interaction data.

Continuing with the process 500, the service 110 executes the operations 204-208 described above with reference to FIG. 2A. Subsequent to the operation 208, the process 500 ends.

FIG. 5B is a sequence diagram illustrating a process 550 of augmenting a web page with relevance information in accordance with an example of the present disclosure. As shown in FIG. 5B, the process 550 includes selected interoperations between processes depicted in FIG. 1.

The process 550 starts with the agent 118 interoperating with the service 122 to authenticate a user. The interoperations between the agent 118 and the service 122 can include authentication request and response messages 502. The agent 118 can be hosted by and establish user authentication with various execution environments in accordance with the examples described herein. These execution environments can include an operating system (e.g., the operating system 120 of FIG. 1) of a host device, a browser (e.g., the browser 102 of FIG. 1), and/or a digital workspace (e.g., as illustrated in FIGS. 9-11).

Continuing with the process 550, the browser 102 communicates the web resource request message 104 of FIG. 1 to the server 106. The server 106 processes the request 104 to generate and transmit the response message 108 to the browser 102.

Continuing with the process 550, the service 110 intercepts the response message 108 and executes the operation 252 described above with reference to FIG. 2B to determine whether the authenticated user is subscribed to receive relevance data. In so doing, the service 110 interoperates with the service 122 via the user account data request and response messages 510 to retrieve a user identifier (e.g., a user account identifier) and interoperates with a relevance data store (e.g. the data store 124 of FIG. 1) to determine whether the authenticated user is subscribed to the service 110.

Continuing with the process 550, the service 110 executes the operations 254-260 described above with reference to FIG. 2B. Within the operation 260, the service 110 transmits an augmented response (e.g., the augmented response 112 of FIG. 1) to the browser. Subsequent to the operation 260, the process 550 ends.

### Computing Devices for Web Resource Relevance Determination Systems

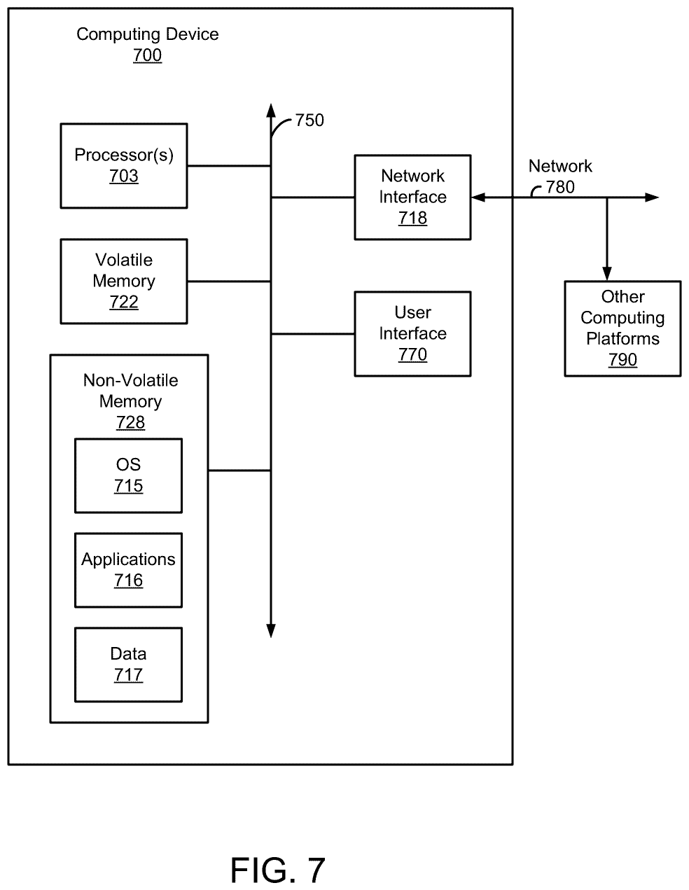

FIG. 7 is a block diagram including a computing device 700 configured to implement various web resource relevance determination systems and processes in accordance with examples disclosed herein.

The computing device 700 includes one or more processor(s) 703, volatile memory 722 (e.g., random access memory (RAM)), non-volatile memory 728, a user interface (UI) 770, one or more network or communication interfaces 718, and a communications bus 750. The computing device 700 may also be referred to as a client device, computing device, endpoint device, computer, or a computer system.

The non-volatile (non-transitory) memory 728 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 770 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, one or more accelerometers, one or more visors, etc.).

The non-volatile memory 728 stores an operating system 715, one or more applications or programs 716, and data 717. The operating system 715 and the application 716 include sequences of instructions that are encoded for execution by the processor(s) 703. Execution of these instructions results in manipulated data. Prior to their execution, the instructions can be copied to the volatile memory 722. In some examples, the volatile memory 722 can include one or more types of RAM and/or a cache memory that can offer a faster response time than a main memory. Data can be entered through the user interface 770 or received from the other I/O devices, such as the network interface 718. The various elements of the device 700 described above can communicate with one another via the communications bus 750.

The illustrated computing device 700 is shown merely as an example client device or server and can be implemented within any computing or processing environment with any type of physical or virtual machine or set of physical and virtual machines that can have suitable hardware and/or software capable of operating as described herein.

The processor(s) 703 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor(s) 703 can be analog, digital or mixed. In some examples, the processor(s) 703 can be one or more local physical processors or one or more remotely located physical processors. A processor including multiple processor cores and/or multiple processors can provide functionality for parallel, simultaneous execution of instructions or for parallel, simultaneous execution of one instruction on more than one piece of data.

The network interfaces 718 can include one or more interfaces to enable the computing device 700 to access a computer network 780 such as a Local Area Network (LAN), a Wide Area Network (WAN), a Personal Area Network (PAN), or a public network (e.g., the Internet) through a variety of wired and/or wireless connections, including cellular connections and Bluetooth connections. In some examples, the network 780 may allow for communication with other computing devices 790, to enable distributed computing. The network 780 can include, for example, one or more private and/or public networks over which computing devices can exchange data.

In described examples, the computing device 700 can execute an application on behalf of a user of a client device. For example, the computing device 700 can execute one or more virtual machines managed by a hypervisor. Individual virtual machines can provide an execution session within which applications execute on behalf of a user or a client device, such as a hosted desktop session. The computing device 700 can also execute a terminal services session to provide a hosted desktop environment. The computing device 700 can provide access to a remote computing environment including one or more applications, one or more desktop applications, and one or more desktop sessions in which one or more applications can execute.

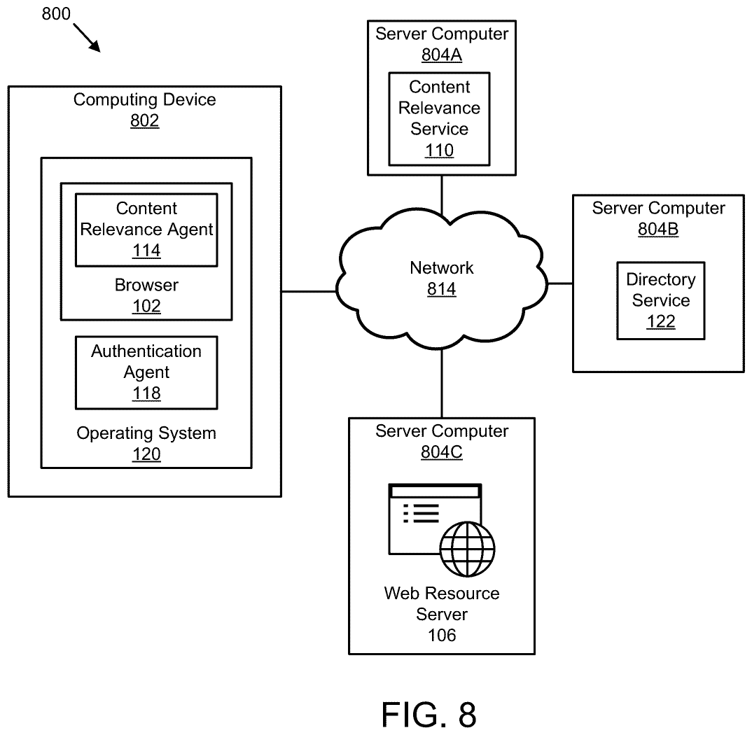

FIG. 8 illustrates a web resource relevance determination system (e.g., the system 100 of FIG. 1) configured for operation within a distributed computing system 800 comprising computing devices. As shown in FIG. 8, the distributed computing system 800 includes server computers 804A-804C that are configured to interoperate with one another and an endpoint computing device 802 via a network 814.

The server computer 804A is configured to host the service 110 of FIG. 1. The server computer 804B is configured to host the service 122 of FIG. 1. The server computer 804C is configured to host the server 106 of FIG. 1. The endpoint device 802 is configured to host the browser 102, the agent 114, the agent 118, and the operating system 120 of FIG. 1. Examples of the endpoint computing device 802 and the server computers 804A-804C can be implemented using the computing device 700 of FIG. 7.

FIG. 9 illustrates a web resource relevance determination system (e.g., the system 100 of FIG. 1) configured for operation within a distributed computing system 900 comprising computing devices. As shown in FIG. 9, the distributed computing system 900 includes server computers 904A-904E that are configured to interoperate with one another and an endpoint computing device 902 via a network 914.

The server computer 904A is configured to host the service 110 of FIG. 1. The server computer 904B is configured to host the service 122 of FIG. 1. The server computer 904C is configured to host the server 106 of FIG. 1. The server computer 904D is configured to host a digital workspace service 910, such as the CITRIX WORKSPACE service. The server computer 904E is configured to host a virtualization agent 912A. The endpoint device 902 is configured to host a digital workspace client 908 and a virtualization agent 912B. As shown in FIG. 9, the digital workspace client 908 incorporates the browser 102, the agent 114, and the agent 118 of FIG. 1. Examples of the endpoint computing device 902 and the server computers 904A-904E can be implemented using the computing device 700 of FIG. 7.

As shown in FIG. 9, the virtualization agent 912A and the virtualization agent 912B are configured to interoperate within a virtualization infrastructure. This virtualization infrastructure enables an application executing within a first physical computing environment (e.g., the server computer 904E) to be accessed by a user of a second physical computing environment (e.g., the endpoint computing device 902) as if the application was executing within the second physical computing environment. Within the virtualization infrastructure, the virtualization agent 912A is configured to make a computing environment in which it operates available to execute virtual computing sessions. The virtualization agent 912A can be further configured to manage connections between these virtual computing sessions and other processes within the virtualization infrastructure, such as the virtualization agent 912B. In a complementary fashion, the virtualization agent 912B is configured to instigate and connect to the virtual computing sessions managed by the virtualization agent 912A. The virtualization agent 912B is also configured to interoperate with other processes executing within its computing environment (e.g., the digital workspace client 908) to provide those processes with access to the virtual computing sessions and the virtual resources therein. Within the context of a CITRIX HDX virtualization infrastructure, the virtualization agent 912A can be implemented as, for example, a virtual delivery agent installed on a physical or virtual server or desktop and the virtualization agent 912B can be implemented as a local service in support of the digital workspace client 908. In this context, the digital workspace client 908 can include, for example, a CITRIX WORKSPACE client or CITRIX RECEIVER for hypertext markup language (HTML) 5 browsers. As explained above, in some examples, the digital workspace client 908 includes the embedded browser 102. The embedded browser can be implemented, for example, using the Chromium Embedded Framework.

Continuing with the example illustrated in FIG. 9, the digital workspace client 908 and the digital workspace service 910 collectively implement a digital workspace application. This digital workspace application is configured to deliver and manage a user's applications, data, and desktops in a consistent and secure manner, regardless of the user's device or location. The digital workspace application enhances the user experience by streamlining and automating those tasks that a user performs frequently, such as approving expense reports, confirming calendar appointments, submitting helpdesk tickets, and reviewing vacation requests. The workspace application allows users to access functionality provided by multiple enterprise applications—including SaaS applications, web applications, desktop applications, and proprietary applications—through a single interface rendered by the digital workspace client 908.

In certain examples, the digital workspace service 910 is configured to control the applications, data, and desktops that users may access via the digital workspace client 908 and to help establish connections between the digital workspace client 908 and the available applications, data, and desktops. As such, the digital workspace service 910 exposes and implements an administrative interface configured to interact with administrators. The digital workspace service 910 is configured to receive, via this administrative interface, configuration information that specifies the applications, data, and desktops that users may access via the digital workspace client 908.

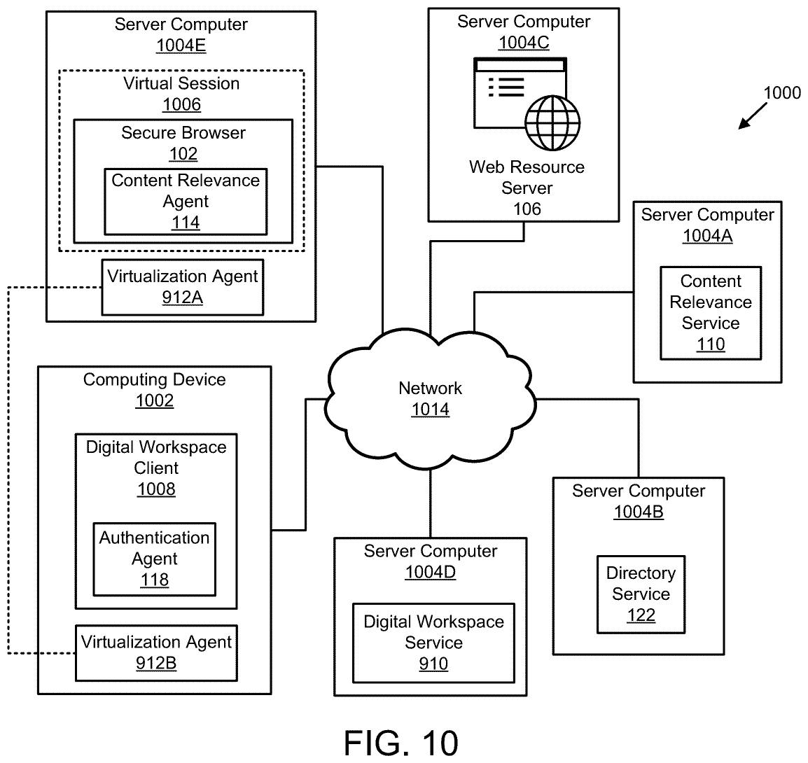

FIG. 10 illustrates a web resource relevance determination system (e.g., the system 100 of FIG. 1) configured for operation within a distributed computing system 1000 comprising computing devices. As shown in FIG. 10, the distributed computing system 1000 includes server computers 1004A-1004E that are configured to interoperate with one another and an endpoint computing device 1002 via a network 1014.

The server computer 1004A is configured to host the service 110 of FIG. 1. The server computer 1004B is configured to host the service 122 of FIG. 1. The server computer 1004C is configured to host the server 106 of FIG. 1. The server computer 1004D is configured to host the service 910 of FIG. 9. The server computer 1004E is configured to host the agent 912A of FIG. 9 and the browser 102 of FIG. 1 within a virtual computing session 1006. The endpoint device 1002 is configured to host a digital workspace client 1008 and the virtualization agent 912B of FIG. 9. The digital workspace client 1008 is configured to host the agent 118 of FIG. 1. Examples of the endpoint computing device 1002 and the server computers 1004A-1004E can be implemented using the computing device 700 of FIG. 7.

As shown in FIG. 10, the digital workspace client 1008 implements the functionality of the digital workspace client 908 but omits the browser 102. Rather, in examples illustrated by FIG. the browser 102 is implemented as a secure (virtual) browser hosted within the virtual computing session 1006 and accessible by the digital workspace client 1008 via the virtualization infrastructure implemented by the virtualization agents 912A and 912B and the digital workspace service 910.

FIG. 11 illustrates a web resource relevance determination system (e.g., the system 100 of FIG. 1) configured for operation within a distributed computing system 1100 comprising computing devices. As shown in FIG. 11, the distributed computing system 1100 includes server computers 1104A-1104D that are configured to interoperate with one another via a network 1114. The distributed computing system 1100 further includes an endpoint computing device 1102 and the server computer 1104E that are configured to interoperate with one another via a private network that includes the server computer 1104A, which is operating as a gateway between the private network and the network 1114.

The server computer 1104A is configured to host the service 110 of FIG. 1. The server computer 1104B is configured to host the service 122 of FIG. 1. The server computer 1104C is configured to host the server 106 of FIG. 1. The server computer 1104D is configured to host the service 910 of FIG. 9. The server computer 1104E is configured to host the agent 912A of FIG. 9. The server computer 1104E is further configured to host the browser 102 and the agent 114 of FIG. 1 in a virtual computing session 1110. The endpoint device 1102 is configured to host a digital workspace client 1108, the agent 118 of FIG. 1, and the virtualization agent 912B of FIG. 9. Examples of the endpoint computing device 1102 and the server computers 1104A-1104E can be implemented using the computing device 700 of FIG. 7.

As shown in FIG. 11, the digital workspace client 1108 implements the functionality of the digital workspace client 908 of FIG. 9 but omits the browser 102 and the agent 114, which are implemented and made functional and accessible to the workspace client 1108 via the virtual session 1110. In some examples, the server computer 1104A is a part of the virtualization infrastructure along with the virtualization agent 912A, the virtualization agent 912B, the digital workspace client 1108, and the digital workspace service 910. For instance, in some examples, the server computer 1104A includes a CITRIX ADC.

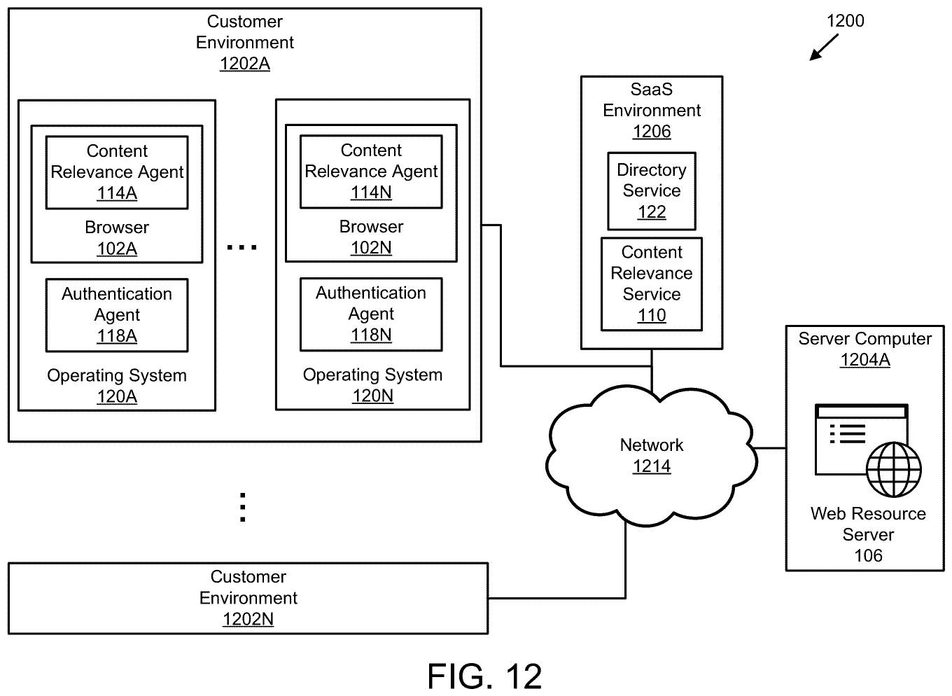

FIG. 12 illustrates a web resource relevance determination system (e.g., the system 100 of FIG. 1) configured for operation within a distributed computing system 1200 comprising computing devices. As shown in FIG. 12, the distributed computing system 1200 includes customer computing environments 1202A-1202N that are configured to interoperate with server computer 1204A and a SaaS environment 1206 via a network 1214.

The environments 1202A-1202N and 1206 can individually include one or more computing devices in communication via a private network and/or one or more virtual computing devices hosted within a cloud computing service, such as MICROSOFT AZURE. The customer environment 1202A is configured to host a plurality of instances of the operating system 120 of FIG. 1 (e.g., 120A through 120N) and all of the processes hosted thereby. Two or more of the browsers 102A-102N may be associated with distinct users (e.g., employees of the customer organization that owns the customer environment 1202A. Each of the customer environments 1202A-1202N may have a configuration similar to or the same as customer environment 1202A. As shown in FIG. 12, the SaaS environment 1206 is configured to host the services 110 and 122 of FIG. 1. The server computer 1204A is configured to host the server 106 of FIG. 1. Examples of the computing devices used to implement the server computer 1204A and the environments 1202A-1202N and 1206 can be implemented using the computing device 700 of FIG. 7. It should be noted that, in the web resource recognition system of FIG. 12, one or more instances of the service 110 can provide relevance determination functionality to each of the customer environments 1202A-1202N.

The distributed computing systems 800-1200 are but a few examples of many potential configurations that can be used to implement web resource recognition systems. As such, the examples disclosed herein are not limited to the particular configurations of computing devices and other configurations are considered to fall within the scope of this disclosure.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

The processes as disclosed herein individually depict one particular sequence of operations in a particular example. Some operations are optional and, as such, can be omitted in accord with one or more examples. Additionally, the order of operations can be altered, or other operations can be added, without departing from the scope of the apparatus and methods described herein.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A method of augmenting web pages with relevance information, the method comprising:
receiving, from a server, a response addressed to a browser;
detecting, within the response addressed to the browser, one or more identifiers of one or more web resources;
determining relevance information associated with the one or more web resources;
embedding the relevance information into the response to generate an augmented response indicating the relevance information and different from the response; and
communicating the augmented response to the browser.

2. The method of claim 1, wherein determining the relevance information comprises:
monitoring interactions between one or more users and the one or more web resources;
generating interaction data specifying one or more features of the interactions;
determining one or more scores for the one or more web resources based on the one or more features; and
generating the relevance information based on the one or more scores.

3. The method of claim 2, wherein generating the interaction data comprises calculating at least one feature of the one or more features that is indicative of comprehensibility of at least one web resource of the one or more web resources.

4. The method of claim 3, wherein calculating the at least one feature comprises tracking time spent by users interacting with the at least one web resource.

5. The method of claim 4, wherein tracking the time spent by users comprises tracking time spent by users positioned within an identified role in an organization.

6. The method of claim 1, wherein determining the relevance information comprises determining relevance information specific to an organizational role of a user of the browser based on a data structure that associates user identifiers with organizational roles.

7. The method of claim 6, wherein determining the relevance information comprises determining one or more of a target role of at least one web resource of the one or more web resources, a resource quality of at least one web resource of the one or more web resources, or an indication of a most recent browser access of at least one web resource of the one or more web resources.

8. The method of claim 7, wherein:
the one or more web resources comprise a plurality of web resources; and
determining the resource quality comprises identifying a plurality of clusters within the plurality of web resources.

9. A computer system comprising:
at least one memory; and
at least one processor coupled with the at least one memory and configured to
receive, from a server, a response addressed to a browser;
detect, within the response addressed to the browser, one or more identifiers of one or more web resources;
determine relevance information associated with the one or more web resources;
embed the relevance information into the response to generate an augmented response indicating the relevance information and different from the response; and
communicate the augmented response to the browser.

10. The computer system of claim 9, wherein to determine the relevance information comprises to:
monitor interactions between one or more users and the one or more web resources;
generate interaction data specifying one or more features of the interactions;
determine one or more scores for the one or more web resources based on the one or more features; and
generate the relevance information based on the one or more scores.

11. The computer system of claim 10, wherein to generate the interaction data comprises to calculate at least one feature of the one or more features that is indicative of comprehensibility of at least one web resource of the one or more web resources.

12. The computer system of claim 11, wherein to calculate the at least one feature comprises to track time spent by users interacting with the at least one web resource.

13. The computer system of claim 12, wherein to track the time spent by users comprises to track time spent by users positioned within an identified role in an organization.

14. The computer system of claim 9, wherein to determine the relevance information comprises to determine relevance information specific to an organizational role of a user of the browser based on a data structure that associates user identifiers with organizational roles.

15. The computer system of claim 14, wherein to determine the relevance information comprises to determine one or more of a target role of at least one web resource of the one or more web resources, a resource quality of at least one web resource of the one or more web resources, or an indication of a most recent browser access of at least one web resource of the one or more web resources.

16. (canceled)

17. One or more non-transitory computer readable media storing processor executable instructions to determine relevance of web resources, the instructions comprising instructions to:
receive, from a server, a response addressed to a browser;
detect, within the response addressed to the browser, one or more identifiers of one or more web resources;
determine relevance information associated with the one or more web resources;
embed the relevance information into the response to generate an augmented response indicating the relevance information and different from the response; and
communicate the augmented response to the browser.

18. The one or more non-transitory computer readable media of claim 17, wherein the instructions to determine the relevance information comprise instructions to:
monitor interactions between one or more users and the one or more web resources;
generate interaction data specifying one or more features of the interactions;
determine one or more scores for the one or more web resources based on the one or more features; and
generate the relevance information based on the one or more scores.

19. The one or more non-transitory computer readable media of claim 18, wherein the instructions to generate the interaction data comprise instructions to calculate time spent by users interacting with at least one web resource of the one or more web resources.

20. The one or more non-transitory computer readable media of claim 18, wherein the instructions to determine the relevance information comprise instructions to determine relevance information specific to an organizational role of a user of the browser based on a data structure that associates user identifiers with organizational roles.

21. The method of claim 2, wherein monitoring the interactions between the one or more users and the one or more web resources comprises monitoring, by one or more processes within a digital workspace, interactions between the one or more users and one or more web resources accessible to the one or more users through the digital workspace.
